(19) United States
(12) Patent Application Publication
(10) Pub. No.: US 2024/0279368 A1
(43) Pub. Date: Aug. 22, 2024

(54) A PROCESS FOR PRODUCING A MULTIMODAL ETHYLENE POLYMER AND FILMS PREPARED THEREFROM

(71) Applicant: BOREALIS AG, Vienna (AT)

(72) Inventors: Felice DE SANTIS, Linz (AT); Tuan Anh TRAN, Linz (AT); Victor SUMERIN, Kulloo (FI); Markku VAHTERI, Porvoo (FI); Anna Maria HARTL, Linz (AT)

(21) Appl. No.: 18/569,034

(22) PCT Filed: Jun. 10, 2022
(86) PCT No.: PCT/EP2022/065825

§ 371 Date: Dec. 11, 2023

(30) Foreign Application Priority Data
Jun. 11, 2021 (EP) 21179136.3

(51) Int. Cl. C08F 10/02; C08J 5/18; C08L 23/08

(52) U.S. Cl. CPC C08F 10/02; C08J 5/18; C08L 23/0815; C08J 2323/06; C08J 2323/08; C08J 2423/06; C08J 2423/08; C08L 2205/025; C08L 2308/00; C08L 2314/02

(57) ABSTRACT

A process for producing a multimodal ethylene polymer comprising the steps of (i) polymerising ethylene in a first polymerisation step in the presence of a Ziegler-Natta polymerisation catalyst to produce a first ethylene homopolymer (PEI) having a melt flow rate MFR₂ of from 100 to 300 g/10 min (ISO 1133-1 at 190° C. under 2.16 kg load); (ii) polymerising ethylene in a second polymerisation step in the presence of the first ethylene homopolymer to produce a first ethylene polymer mixture (PEM1) comprising the first ethylene homopolymer and a second ethylene homopolymer, said first ethylene polymer mixture having a melt flow rate MFR₂ of from 200 to 1000 g/10 min, and wherein the MFR₂ of the first ethylene homopolymer (PEI) is lower than the MFR₂ of the first ethylene polymer mixture (PEM1); and (iii) copolymerising ethylene and at least one alpha-olefin comonomer in a third polymerisation step in the presence of the first ethylene polymer mixture to produce a second ethylene polymer mixture (PEM2) comprising the first ethylene polymer mixture and a third ethylene copolymer (PE3), said second ethylene polymer mixture having a density of from 937 to 950 kg/m³ (ISO 1183-2) and a melt flow rate MFR₅ of from 0.1 to 5.0 g/10 min (ISO 1133-1 at 190° C. under 5 kg load).

### FIELD OF THE INVENTION

The present invention is directed to a process for producing a multimodal ethylene polymer, the multimodal ethylene polymer itself and films comprising said multimodal ethylene polymer. Especially, the present invention is directed to a method for making multimodal ethylene copolymer composition by a process comprising polymerising ethylene in at least three polymerisation stages. Further, the present invention is directed to films comprising the multimodal ethylene polymer with improved processability and stiffness.

### BACKGROUND

It is known to produce ethylene copolymers suitable for producing films by copolymerising ethylene in two polymerisation stages, for instance from EP-A-691367 which discloses bimodal ethylene copolymers produced in two fluidized bed reactors.

EP2415598 discloses a multilayer film comprising at least one layer of a multimodal terpolymer, e.g. a bimodal linear low density ethylene/1-butene/C6-C12-alpha-olefin terpolymer. The multimodal polymer comprises a low molecular weight component corresponding ethylene homopolymer or a low molecular weight ethylene copolymer and a high molecular weight component corresponding to ethylene terpolymer with higher alpha-olefin comonomers. Preferably the low molecular weight component is an ethylene homopolymer and the high molecular weight component is ethylene/1-butene/1-hexene terpolymer. The multimodal terpolymer is produced in a two stage polymerisation process.

The use of three polymerisation stages is also known. WO2015/086812 (EP2883887) describes a process for making multimodal ethylene copolymers where the method comprises polymerising ethylene and comonomers in three polymerisation stages, and describes the use of said copolymers for making films. The ethylene copolymer produced according to the process has the density of 906 to 925 kg/m³ and MFR₅ (190° C., 5.0 kg load, ISO1133) of 0.5 to 5.0 g/10 min.

EP2883885 describes similar type of polymers as described in WO2015/086812.

WO2020/136164 describes a multimodal ethylene polymer composition prepared in three steps. The exemplified polymers have two homopolymer components and a terpolymer component with densities around 930 kg/m³. The exemplified polymers are not stiff.

In WO2018/095790 describes a polyethylene film composition having improved throughput and extrudability properties. The exemplified polymers have three copolymer components.

WO 2019/229209 describes a process for the preparation of a multimodal HDPE which is suitable for injection or compression moulded articles, in particular for caps and closures. The density range disclosed in D2 is preferably 950 kg/m³ or more.

WO 2016/124676 discloses a multistep process of the manufacture of an HDPE. The working examples have a density outside the range in claim 1.

EP 3892653 discloses the preparation of a polyethylene composition in a three-step polymerisation process using a Ziegler Natta catalyst.

The present inventors sought a new multimodal ethylene polymer which offers, inter alia, benefits in terms of recycling. When recycling polyethylene, it is easier to use lower density post-consumer recyclate (PCR). If such lower density PCR material is included within a final article, the virgin polymer with which the PCR is combined must compensate for the properties of the PCR. It particular, the low density PCR tends to lack good mechanical properties such as high stiffness. It is therefore preferred if a stiffer virgin material is used as a blending component. The use of a stiffer component risks a reduction in impact strength however and also a reduction in processability. The present inventors sought a new material that offers high stiffness, e.g. in terms of high tensile modulus, as well as good processability and toughness.

Moreover, a stiffer, higher density grade also has advantages in terms of packaging applications, e.g. in down gauging film thickness, if toughness can be maintained.

The present inventors have now found that a trimodal polymer based on two homopolymer components and a copolymer or terpolymer component with an MFR difference between the homopolymer components offers improved processability, e.g. in a monolayer film. This therefore allows an increase in density at lower MFR and hence an increased stiffness compared to commercial grades without loss of toughness or processability. The polymer of the invention has 4 main features:
Higher density than commercial competitor grades to offer higher stiffness (i.e. higher tensile modulus);
Optimised copolymer split to allow a decrease in the density of the third fraction whilst keeping the target final density;
Trimodal design to offer processability and reduced white spots and low extractables
Ziegler Natta catalysis to provide optimal balance between stiffness and toughness.

The invention combines high stiffness (e.g. for a 40 μm film, tensile modulus ˜600 MPa, 23° C.) with good toughness (e.g. for a 40 μm film, DDI˜240 g, 23° C.) obtained with a Ziegler Natta catalyst. The solution is useful for blow film extrusion and outperforms current commercial grades due to its improved stiffness-toughness balance.

### SUMMARY OF THE INVENTION

Viewed from one aspect the invention provides a process for producing multimodal ethylene copolymer comprising the steps of
(i) polymerising ethylene in a first polymerisation step in the presence of a Ziegler-Natta polymerisation catalyst to produce a first ethylene homopolymer (PE1) having a melt flow rate MFR₂ of from 100 to 300 g/10 min;
(ii) polymerising ethylene in a second polymerisation step in the presence of the first ethylene homopolymer to produce a first ethylene polymer mixture (PEM1) comprising the first ethylene homopolymer and a second ethylene homopolymer, said first ethylene polymer mixture having a melt flow rate MFR₂ of from 200 to 1000 g/10 min, and wherein the MFR₂ of the first ethylene homopolymer (PE1) is lower than the MFR₂ of the first ethylene polymer mixture (PEM1); and
(iii) copolymerising ethylene and at least one alpha-olefin comonomer in a third polymerisation step in the presence of the first ethylene polymer mixture to produce a second ethylene polymer mixture (PEM2) comprising the first ethylene polymer mixture and a third ethylene copolymer (PE3), said second ethylene polymer mixture having a density of from 937 to 950 kg/m³ and a melt flow rate MFR₅ of from 0.1 to 5.0 g/10 min.

Viewed from another aspect the invention provides a process for the preparation of a film comprising steps (i) to (iii) above followed by
iv) pelletizing the second polymer mixture and
v) providing a film by film blowing.

Viewed from another aspect the invention provides a multimodal ethylene polymer having density of from 937 to 950 kg/m³ and a melt flow rate MFR₅ of from 0.1 to 5.0 g/10 min comprising:
i) 10 to 30 wt % of a first ethylene homopolymer (PE1);
ii) 15 to 35 wt % a second ethylene homopolymer (PE2) having an MFR₂ which is at least 50 g/10 min higher than the MFR₂ of component i); and
iii) 45 to 65 wt % of a third ethylene copolymer with at least one alpha-olefin comonomer (PE3).

Viewed from another aspect the invention provides the use of a multimodal ethylene polymer as hereinbefore defined or a multimodal ethylene polymer produced by the process of the invention in the manufacture of a film.

### DETAILED DESCRIPTION

The present invention relates to a process for the preparation of a multimodal ethylene polymer, to the polymer itself and to articles comprising that polymer.

### Polymerisation Process

In a first aspect the invention relates to a process for the preparation of a multimodal ethylene polymer which comprises at least three polymerisation steps in the presence of a Ziegler Natta polymerisation catalyst.

The first two steps of the claimed process produce a homopolymer of ethylene, i.e. these components are essentially free of comonomer. The third polymerisation step produces a copolymer and hence at least one comonomer is present during this step.

The at least one α-olefin comonomer present in the third step may be selected from α-olefins having from 4 to 10 carbon atoms and their mixtures. Especially suitable α-olefins are those having from 4 to 8 carbon atoms, including their mixtures. In particular 1-butene, 1-hexene and 1-octene and their mixtures are the preferred α-olefins.

It is especially preferred if the third polymerisation step produces a terpolymer component. Such a component must therefore comprise at least two comonomers in addition to ethylene, e.g. two C4-10 alpha olefins. In particular, a combination of two or more of 1-butene, 1-hexene and 1-octene is used. Ideally, the terpolymer contains two comonomers only, most preferably 1-butene and 1-hexene.

The multimodal ethylene polymer can therefore be regarded as a multimodal ethylene copolymer, especially a multimodal ethylene terpolymer.

### Catalyst

The polymerisation is conducted in the presence of a Ziegler Natta olefin polymerisation catalyst. Ziegler Natta catalysts are useful as they can produce polymers within a wide range of molecular weight and other desired properties with a high productivity. Ziegler Natta catalysts used in the present invention are preferably supported on an external support.

Suitable Ziegler Natta catalysts preferably contain a magnesium compound, an aluminium compound and a titanium compound supported on a particulate support.

The particulate support typically used in Ziegler-Natta catalysts comprises an inorganic oxide support, such as silica, alumina, titania, silica-alumina and silica-titania or a MgCl₂ based support. The catalyst used in the present invention is supported on an inorganic oxide support. Most preferably the Ziegler-Natta catalyst used in the present invention is supported on silica.

The average particle size of the silica support can be typically from 10 to 100 μm. However, it has turned out that special advantages can be obtained if the support has an average particle size from 15 to 30 μm, preferably from 18 to 25 μm. Alternatively, the support may have an average particle size of from 30 a 80 μm, preferably from 30 to 50 μm. Examples of suitable support materials are, for instance, ES747JR produced and marketed by Ineos Silicas (former Crossfield), and SP9-491, produced and marketed by Grace.

The magnesium compound is a reaction product of a magnesium dialkyl and an alcohol. The alcohol is a linear or branched aliphatic monoalcohol. Preferably, the alcohol has from 6 to 16 carbon atoms. Branched alcohols are especially preferred, and 2-ethyl-1-hexanol is one example of the preferred alcohols. The magnesium dialkyl may be any compound of magnesium bonding to two alkyl groups, which may be the same or different. Butyl-octyl magnesium is one example of the preferred magnesium dialkyls.

The aluminium compound is chlorine containing aluminium alkyl. Especially preferred compounds are aluminium alkyl dichlorides, aluminium dialkyl chlorides and aluminium alkyl sesquichlorides.

The transition metal is preferably titanium. The titanium compound is a halogen containing titanium compound, preferably chlorine containing titanium compound. Especially preferred titanium compound is titanium tetrachloride.

The catalyst can be prepared by sequentially contacting the carrier with the above mentioned compounds, as described in EP-A-688794 or WO-A-99/51646. Alternatively, it can be prepared by first preparing a solution from the components and then contacting the solution with a carrier, as described in WO-A-01/55230.

The Ziegler Natta catalyst is used together with an activator, which is also called as cocatalyst. Suitable activators are metal alkyl compounds, typically Group 13 metal alkyl compounds, and especially aluminium alkyl compounds. They include trialkylaluminium compounds, such as trimethylaluminium, triethylaluminium, tri-isobutylaluminium, trihexylaluminium and tri-n-octylaluminium. Aluminium alkyl compounds may also include alkyl aluminium halides, such as ethylaluminium dichloride, diethylaluminium chloride, ethylaluminium sesquichloride, dimethylaluminium chloride and the like and alkylaluminium oxy-compounds, such as methylaluminiumoxane, hexaisobutylaluminiumoxane and tetraisobutylaluminiumoxane and also other aluminium alkyl compounds, such as isoprenylaluminium. Especially preferred cocatalysts are trialkylaluminiums, of which triethylaluminium, trimethylaluminium and tri-isobutylaluminium are particularly preferred.

The amount in which the activator is used depends on the specific catalyst and activator. Typically triethylaluminium is used in such amount that the molar ratio of aluminium to the transition metal, like Al/Ti, is for example from 1 to 1000, preferably from 3 to 100 and in particular from about 5 to about 30 mol/mol.

### Prepolymerisation

In addition to the actual polymerisation steps defined in claim 1, i.e. in addition to the at least three polymerisation steps, the process may comprise a prepolymerisation step preceding the actual polymerisation steps. The purpose of the prepolymerisation is to polymerise a small amount of polymer onto the catalyst at a low temperature and/or a low monomer concentration. By prepolymerisation it is possible to improve the performance of the catalyst in slurry and/or modify the properties of the final polymer. The prepolymerisation step is conducted in slurry.

Thus, the prepolymerisation step may be conducted in a loop reactor. The prepolymerisation is then preferably conducted in an inert diluent, typically a hydrocarbon diluent such as methane, ethane, propane, n-butane, isobutane, pentanes, hexanes, heptanes, octanes etc., or their mixtures. Preferably the diluent is a low-boiling hydrocarbon having from 1 to 4 carbon atoms or a mixture of such hydrocarbons.

The temperature in the prepolymerisation step is typically from 0 to 90° C., preferably from 20 to 80° C. and more preferably from 55 to 75° C. The pressure is not critical and is typically from 1 to 150 bar, preferably from 40 to 80 bar.

The amount of monomer is typically such that from about 0.1 to 1000 grams of monomer per one gram of solid catalyst component is polymerised in the prepolymerisation step. As the person skilled in the art knows, the catalyst particles recovered from a continuous prepolymerisation reactor do not all contain the same amount of prepolymer. Instead, each particle has its own characteristic amount which depends on the residence time of that particle in the prepolymerisation reactor. As some particles remain in the reactor for a relatively long time and some for a relatively short time, then also the amount of prepolymer on different particles is different and some individual particles may contain an amount of prepolymer which is outside the above limits. However, the average amount of prepolymer on the catalyst typically is within the limits specified above.

The molecular weight of the prepolymer may be controlled by hydrogen as it is known in the art. Further, antistatic additive may be used to prevent the particles from adhering to each other or the walls of the reactor, as disclosed in WO-A-96/19503 and WO-A-96/32420.

If a prepolymerisation step is used, it is preferred that the prepolymer is an ethylene homopolymer. Any prepolymer component is regarded as part of the first polymer (PE1). When determining the wt %, MFR, density etc of the first polymer therefore the prepolymer is regarded as a part of the first polymer.

The catalyst components are preferably all (separately or together) introduced to the prepolymerisation step when a prepolymerisation step is present. However, where the solid catalyst component and the cocatalyst can be fed separately it is possible that only a part of the cocatalyst is introduced into the prepolymerisation stage and the remaining part into subsequent polymerisation stages. Also in such cases it is necessary to introduce cocatalyst into the prepolymerisation stage that a sufficient polymerisation reaction is obtained therein.

Typically, the amounts of hydrogen and comonomer are adjusted so that the presence of the prepolymer has no effect on the properties of the final multimodal polymer. Especially, it is preferred that melt flow rate of the prepolymer is greater than the melt flow rate of the final polymer but smaller than the melt flow rate of the polymer produced in the first polymerisation stage. It is further preferred that the density of the prepolymer is greater than the density of the final polymer. Suitably the density is approximately the same as or greater than the density of the polymer produced in the first polymerisation stage. Further, typically the amount of the prepolymer is not more than about 5% by weight of the multimodal ethylene polymer.

### First Polymerisation Step (i) Producing the First Ethylene Homopolymer (PE1)

The first polymerisation step typically operates at a temperature of from 20 to 150° C., preferably from 50 to 110° C. and more preferably from 60 to 100° C. The polymerisation may be conducted in slurry, gas phase or solution. In the first polymerisation step the first ethylene homopolymer is produced. The first ethylene homopolymer has a melt flow rate MFR₂ of from 100 to 300 g/10 min and optionally a density of from 955 to 980 kg/m³.

A preferred MFR₂ is from 150 to 270 g/10 min.

The catalyst may be transferred into the first polymerisation step by any means known in the art. It is thus possible to suspend the catalyst in a diluent and maintain it as homogeneous slurry. Especially preferred it is to use oil having a viscosity from 20 to 1500 mPas as diluent, as disclosed in WO-A-2006/063771. It is also possible to mix the catalyst with a viscous mixture of grease and oil and feed the resultant paste into the first polymerisation step. Further still, it is possible to let the catalyst settle and introduce portions of thus obtained catalyst mud into the first polymerisation step in a manner disclosed, for instance, in EP-A-428054. The first polymerisation step may also be preceded by a prepolymerisation step, in which case the mixture withdrawn from the prepolymerisation step is directed into the first polymerisation step.

Into the first polymerisation step ethylene, optionally an inert diluent, and optionally hydrogen are introduced. Hydrogen and the α-olefin are introduced in such amounts that the melt flow rate MFR₂ and the density of the first ethylene homopolymer are in the desired values.

The polymerisation of the first polymerisation step may be conducted in slurry. Then the polymer particles formed in the polymerisation, together with the catalyst fragmented and dispersed within the particles, are suspended in the fluid hydrocarbon. The slurry is agitated to enable the transfer of reactants from the fluid into the particles.

The polymerisation usually takes place in an inert diluent, typically a hydrocarbon diluent such as methane, ethane, propane, n-butane, isobutane, pentanes, hexanes, heptanes, octanes etc., or their mixtures. Preferably the diluent is a low-boiling hydrocarbon having from 1 to 4 carbon atoms or a mixture of such hydrocarbons. An especially preferred diluent is propane, possibly containing minor amount of methane, ethane and/or butane.

The ethylene content in the fluid phase of the slurry may be from 1 to about 50% by mole, preferably from about 1.5 to about 20% by mole and in particular from about 2 to about 15% by mole. The benefit of having a high ethylene concentration is that the productivity of the catalyst is increased but the drawback is that more ethylene then needs to be recycled than if the concentration was lower.

The slurry polymerisation may be conducted in any known reactor used for slurry polymerisation. Such reactors include a continuous stirred tank reactor and a loop reactor. It is especially preferred to conduct the polymerisation in loop reactor. In such reactors the slurry is circulated with a high velocity along a closed pipe by using a circulation pump. Loop reactors are generally known in the art and examples are given, for instance, in U.S. Pat. Nos. 4,582,816, 3,405,109, 3,324,093, EP-A-479186 and U.S. Pat. No. 5,391,654.

If the first ethylene homopolymer is produced in conditions where the ratio of the α-olefin to ethylene is not more than about 400 mol/kmol, such as not more than 300 mol/kmol, then it is usually advantageous to conduct the slurry polymerisation above the critical temperature and pressure of the fluid mixture. Such operation is described in U.S. Pat. No. 5,391,654.

When the first polymerisation step is conducted as slurry polymerisation the polymerisation in the first polymerisation step is conducted at a temperature within the range of from 50 to 115° C., preferably from 70 to 110° C. and in particular from 80 to 105° C. The pressure in the first polymerisation step is then from 1 to 300 bar, preferably from 40 to 100 bar.

The amount of hydrogen is adjusted based on the desired melt flow rate of the first ethylene homopolymer and it depends on the specific catalyst used. For many generally used Ziegler Natta catalysts the molar ratio of hydrogen to ethylene is for example from 10 to 2000 mol/kmol, preferably from 20 to 1000 mol/kmol and in particular from 40 to 800 mol/kmol.

The polymerisation of the first polymerisation step may also be conducted in gas phase. A preferable embodiment of gas phase polymerisation reactor is a fluidised bed reactor. There the polymer particles formed in the polymerisation are suspended in upwards moving gas. The gas is introduced into the bottom part of the reactor. The upwards moving gas passes the fluidised bed wherein a part of the gas reacts in the presence of the catalyst and the unreacted gas is withdrawn from the top of the reactor. The gas is then compressed and cooled to remove the heat of polymerisation. To increase the cooling capacity it is sometimes desired to cool the recycle gas to a temperature where a part of the gas condenses. After cooling the recycle gas is reintroduced into the bottom of the reactor. Fluidised bed polymerisation reactors are disclosed, among others, in U.S. Pat. Nos. 4,994,534, 4,588,790, EP-A-699213, EP-A-628343, FI-A-921632, FI-A-935856, U.S. Pat. No. 4,877,587, FI-A-933073 and EP-A-75049.

According to the preferred embodiment of present invention, the polymerisation of the first polymerisation step is conducted in slurry. Further, suitably the polymerisation is conducted at a temperature exceeding the critical temperature of the fluid mixture and pressure exceeding the critical pressure of the fluid mixture.

Typically the density of the first ethylene homopolymer is for example from 960 to 980 kg/m³. The polymerisation is preferably conducted as a slurry polymerisation in liquid diluent at a temperature of from 75° C. to 100° C., such as from 80 to 95° C. and a pressure of from 30 bar to 100 bar, such as from 40 to 80 bar, like from 50 to 80 bar.

The polymerisation rate in the first polymerisation step is suitably controlled to achieve the desired amount of the first ethylene homopolymer in the second ethylene polymer mixture.

The molar ratio of hydrogen to ethylene is suitably from 50 to 350 mol/kmol, preferably from 75 to 325 mol/kmol and in particular from 100 to 300 mol/kmol in the first polymerisation step.

The polymerisation rate is suitably controlled by adjusting the ethylene concentration in the first polymerisation step. When the first polymerisation step is conducted as slurry polymerisation in the loop reactor the mole fraction of ethylene in the reaction mixture is suitably for example from 0.5 to 10% by mole and preferably from 1 to 8% by mole.

The amount of first polymer in the multimodal ethylene copolymer is preferably 10 to 30% by weight, preferably 13 to 25% by weight, further preferred 15 to 23% by weight.

The amount of first polymer and prepolymer combined in the multimodal ethylene copolymer is preferably 11 to 30% by weight, preferably 13 to 25% by weight, further preferred 15 to 23% by weight. In one embodiment there is 18 to 25 wt % of first polymer and prepolymer combined.

### Second Polymerisation Step

The second ethylene homopolymer is produced in the second polymerisation step in the presence of the first homopolymer of ethylene.

The second polymerisation step typically operates at a temperature of from 20 to 150° C., preferably from 50 to 110° C. and more preferably from 60 to 100° C. The polymerisation may be conducted in slurry, gas phase or solution. In the second polymerisation step the second homopolymer of ethylene is produced in the presence of the first homopolymer of ethylene. The first ethylene homopolymer (PE1) and the second ethylene homopolymer (PE2) together form the first ethylene polymer mixture (PEM1). The first ethylene polymer mixture preferably has a density of from 955 to 980 kg/m³ and a melt flow rate MFR₂ of from 200 to 1000 g/10 min.

The first ethylene homopolymer (PE1) is transferred from the first polymerisation step to the second polymerisation step by using any method known to the person skilled in the art. If the first polymerisation step is conducted as slurry polymerisation in a loop reactor, it is advantageous to transfer the slurry from the first polymerisation step to the second polymerisation step by means of the pressure difference between the first polymerisation step and the second polymerisation step. The catalyst used in the first polymerisation step is also transferred to the second step therefore.

Into the second polymerisation step ethylene, optionally an inert diluent, and optionally hydrogen are introduced. Hydrogen is introduced in such amounts that the melt flow rate MFR₂ and the density of the first ethylene polymer mixture are within the desired values.

The polymerisation of the second polymerisation step may be conducted in slurry in the same way as it was discussed above for the first polymerisation step.

The amount of hydrogen in the second polymerisation step is adjusted based on the desired melt flow rate of the first ethylene polymer mixture and it depends on the specific catalyst used. For many generally used Ziegler Natta catalysts the molar ratio of hydrogen to ethylene is for example from 100 to 2000 mol/kmol, preferably from 200 to 1000 mol/kmol and in particular from 250 to 800 mol/kmol.

The polymerisation of the second polymerisation step may also be conducted in gas phase in the same way as was discussed above for the first polymerisation step. Preferably the second polymerisation step is conducted in slurry phase as described above.

The molar ratio of hydrogen to ethylene is suitably from 350 to 600 mol/kmol, preferably from 375 to 550 mol/kmol and in particular from 400 to 500 mol/kmol in the second polymerisation step.

Further, suitably the polymerisation is conducted at a temperature exceeding the critical temperature of the fluid mixture and pressure exceeding the critical pressure of the fluid mixture.

The polymerisation rate in the second polymerisation step is suitably controlled to achieve the desired amount of the second ethylene homopolymer in the second ethylene polymer mixture. Preferably the multimodal ethylene polymer of the invention comprises the second ethylene polymer in an amount from 15 to 35% by weight, preferably 18 to 35% by weight, further preferred 18 to 32% by weight.

The multimodal ethylene polymer of the invention preferably comprises the combination of PE1 and PE2 (i.e. PEM1) in an amount of 45 to 55 wt %.

The polymerisation rate is suitably controlled by adjusting the ethylene concentration in the second polymerisation step. When the second polymerisation step is conducted as slurry polymerisation in the loop reactor the mole fraction of ethylene in the reaction mixture is suitably from 2 to 10% by mole and preferably from 3 to 8% by mole. The mole fraction of ethylene in % by mole in the reaction mixture in the second polymerisation step may thereby be lower than the mole fraction of ethylene in % by mole in the reaction mixture in the first polymerisation step.

As indicated above the melt flow rate MFR₂ of the first ethylene homopolymer (PE1) is in the range 100 to 300 g/10 min and the melt flow rate MFR₂ of the first ethylene mixture (PEM1) is in the range 200 to 1000 g/10 min and MFR₂ (PE1)<MFR₂(PEM1), i.e. the MFR₂ of the polymer produced in the first reactor is lower than the MFR₂ of the polymer mixture produced in the second polymerisation reactor. According to a preferred embodiment the ratio of MFR₂(PEM1)/MFR₂ (PE1) may be for example between more than 1 and 10, preferably between 1.5 and 5, such as 1.5 to 4.

Ideally, the MFR difference between the first and second homopolymers is as high as possible. Ideally, the MFR difference between the first homopolymer and PEM1 is as high as possible e.g. MFR₂ of first homopolymer polymer may be at least 50 g/10 min, such as at least 100 g/10 min such as 100 to 300 g/10 min lower than the MFR₂ of PEM1.

The MFR₂ of PEM1 is preferably 300 to 600 g/10 min, such as 350 to 600 g/10 min.

The MFR₂ of PE2 is preferably 500 to 1200, such as 600 to 1200 g/10 min.

The polymer mixture PEM1 may comprise 30 to 60 wt % of the first ethylene homopolymer and 70 to 40 wt % of the second ethylene homopolymer. In some embodiments, there is an excess of second polymer, e.g. 55 to 70 wt % of 2nd ethylene homopolymer in PEM1. In one embodiment PEM1 contains the same amount of first and second ethylene homopolymers.

### Third Polymerisation Step

In the third polymerisation step the second ethylene polymer mixture (PEM2) comprising the first ethylene polymer mixture (PEM1) and the third ethylene copolymer (PE3) is formed.

Into the third polymerisation step, along with PEM1 and the catalyst from the second step, are introduced ethylene, at least one α-olefin having 4 to 10 carbon atoms, hydrogen and optionally an inert diluent. The polymerisation in third polymerisation step is preferably conducted at a temperature within the range of from 50 to 100° C., preferably from 60 to 100° C. and in particular from 70 to 95° C. The pressure in the third polymerisation step is for example from 1 to 300 bar, preferably from 5 to 100 bar.

The polymerisation in the third polymerisation step may be conducted in slurry. The polymerisation may then be conducted along the lines as was discussed above for the first and second polymerisation steps.

The amount of hydrogen in the third polymerisation step is adjusted for achieving the desired melt flow rate of the second ethylene polymer mixture. The molar ratio of hydrogen to ethylene depends on the specific catalyst used. For many generally used Ziegler Natta catalysts the molar ratio of hydrogen to ethylene is for example from 0 to 50 mol/kmol, preferably from 3 to 35 mol/kmol.

Furthermore, the amount of α-olefin having from 4 to 10 carbon atoms is adjusted to reach the targeted density. The ratio of the α-olefin (sum of α-olefins) to ethylene depends on the type of the catalyst and the type of the α-olefin. The ratio is typically for example from 100 to 1000 mol/kmol, preferably from 150 to 800 mol/kmol. If more than one α-olefin is used the ratio of the α-olefin to ethylene is the ratio of the sum of all the α-olefins to ethylene.

The α-olefin is preferably an α-olefin of 4 to 8 carbon atoms or mixtures thereof. In particular 1-butene, 1-hexene and 1-octene and their mixtures are the preferred α-olefins, especially preferred 1-butene and 1-hexene.

As previously noted, it is preferred if the third polymer comprises at least two, ideally two, comonomers. It is preferred that these are 1-butene and 1-hexene. It is also preferred if the higher alpha olefin comonomer is present in excess relative to the lower alpha olefin comonomer. For example, if 1-butene and 1-hexene are used in the third polymer there is preferably at least 60 wt % hexene and no more than 40 wt % butene, e.g. 70 to 90 wt % 1-hexene and 10 to 30 wt % 1-butene based on the total weight of comonomers present in the third polymer. It is preferred therefore if the third copolymer comprises 70 to 90 wt % of the higher alpha olefin and 10 to 30 wt % of the lower alpha olefin based on the total weight of comonomers present in the third polymer.

The polymerisation in the third polymerisation step may be, and preferably is, conducted in gas phase. In gas phase polymerisation using a Ziegler Natta catalyst hydrogen is typically added in such amount that the ratio of hydrogen to ethylene is for example from 3 to 100 mol/kmol, preferably from 4 to 50 mol/kmol for obtaining the desired melt index of the second ethylene polymer mixture. The amount of α-olefin having from 4 to 10 carbon atoms is adjusted to reach the targeted density of the second ethylene polymer mixture. The ratio of the α-olefin to ethylene is typically from 100 to 1000 mol/kmol, preferably from 150 to 800 mol/kmol, further preferred <150 to 300 mol/kmol. If more than one α-olefin is used the ratio of the α-olefin to ethylene is the ratio of the sum of all the α-olefins to ethylene.

The gas phase reactor preferably is a vertical fluidised bed reactor. There the polymer particles formed in the polymerisation are suspended in upwards moving gas. The gas is introduced into the bottom part of the reactor. The upwards moving gas passes the fluidised bed wherein a part of the gas reacts in the presence of the catalyst and the unreacted gas is withdrawn from the top of the reactor. The gas is then compressed and cooled to remove the heat of polymerisation. To increase the cooling capacity it is sometimes desired to cool the recycle gas to a temperature where a part of the gas condenses. After cooling the recycle gas is reintroduced into the bottom of the reactor. Fluidised bed polymerisation reactors are disclosed, among others, in U.S. Pat. Nos. 4,994,534, 4,588,790, EP-A-699213, EP-A-628343, FI-A-921632, FI-A-935856, U.S. Pat. No. 4,877,587, FI-A-933073 and EP-A-75049.

When the second polymerisation step is conducted in slurry and the third polymerisation step is conducted in gas phase, the polymer is suitably transferred from the second polymerisation step into the third polymerisation step as described in EP-A-1415999. The procedure described in paragraphs to of EP-A-1415999 provides an economical and effective method for product transfer.

The conditions in the third polymerisation step are adjusted so that the resulting second ethylene polymer mixture (PEM2) has MFR₅ of from 0.1 to 5 g/10 min, preferably 0.5 to 2.5 g/10 min, preferably 0.75 to 2.0 g/10 min. Furthermore, the second ethylene polymer mixture has a density in the range of 937 to 950 kg/m³, 939 to 945 kg/m³. The multimodal ethylene polymer also preferably has a density in the range of 937 to 950 kg/m³, 939 to 945 kg/m³. The multimodal ethylene polymer also preferably has MFR₅ of from 0.1 to 5 g/10 min, preferably 0.5 to 2.5 g/10 min, preferably 0.75 to 2.0 g/10 min. Preferably the multimodal ethylene polymer is the same as the second ethylene polymer mixture.

The polymerisation rate in the third polymerisation step is suitably controlled to achieve the desired amount of the third ethylene copolymer in the second ethylene polymer mixture. Preferably the second ethylene polymer mixture contains from 45 to 65% by weight, preferably 45 to 62% by weight, further preferred 45 to 60% by weight of the third ethylene copolymer. The polymerisation rate is suitably controlled by adjusting the ethylene concentration in the third polymerisation step. When the third polymerisation step is conducted in gas phase the mole fraction of ethylene in the reactor gas is suitably from 3 to 50% by mole and preferably from 5 to 15% by mole.

In addition to ethylene, comonomer and hydrogen the gas also comprises an inert gas. The inert gas can be any gas which is inert in the reaction conditions, such as a saturated hydrocarbon having from 1 to 5 carbon atoms, nitrogen or a mixture of the above-mentioned compounds. Suitable hydrocarbons having from 1 to 5 carbon atoms are methane, ethane, propane, n-butane, isobutane, n-pentane, isopentane and mixtures thereof.

The multimodal ethylene polymer therefore preferably contains from 45 to 65% by weight, preferably 45 to 62% by weight, further preferred 45 to 55% by weight of the third polymer.

### Post Reactor Treatment

When the multimodal ethylene polymer has been removed from the polymerisation reactor it is subjected to process steps for removing residual hydrocarbons from the polymer. Such processes are well known in the art and can include pressure reduction steps, purging steps, stripping steps, extraction steps and so on. Also combinations of different steps are possible.

According to one preferred process a part of the hydrocarbons is removed from the polymer powder by reducing the pressure. The powder is then contacted with steam at a temperature of from 90 to 110° C. for a period of from 10 minutes to 3 hours. Thereafter the powder is purged with inert gas, such as nitrogen, over a period of from 1 to 60 minutes at a temperature of from 20 to 80° C.

According to another preferred process the polymer powder is subjected to a pressure reduction as described above. Thereafter it is purged with an inert gas, such as nitrogen, over a period of from 20 minutes to 5 hours at a temperature of from 50 to 90° C. The inert gas may contain from 0.0001 to 5%, preferably from 0.001 to 1%, by weight of components for deactivating the catalyst contained in the polymer, such as steam.

The purging steps are preferably conducted continuously in a settled moving bed. The polymer moves downwards as a plug flow and the purge gas, which is introduced to the bottom of the bed, flows upwards.

Suitable processes for removing hydrocarbons from polymer are disclosed in WO-A-02/088194, EP-A-683176, EP-A-372239, EP-A-47077 and GB-A-1272778.

After the removal of residual hydrocarbons the polymer is preferably mixed with additives as it is well known in the art to form a polymer composition. Such additives include antioxidants, process stabilisers, neutralisers, lubricating agents, nucleating agents, pigments and so on.

The polymer particles are mixed with additives and extruded to pellets as it is known in the art. Preferably a counter-rotating twin screw extruder is used for the extrusion step. Such extruders are manufactured, for instance, by Kobe and Japan Steel Works. A suitable example of such extruders is disclosed in EP-A-1600276. Typically the specific energy input (SEI) is during the extrusion within the range of from 100 to 230 kWh/ton. The melt temperature is typically from 220 to 290° C.

### Preferred Embodiments

In an embodiment of the process according to the invention, at least one of the first and the second polymerisation step(s) is/are conducted as a slurry polymerisation in a loop reactor, preferably both the first and the second polymerisation steps are conducted as a slurry polymerisation in two loop reactors, preferably connected in series. It is then preferred if the third step is carried out in the gas phase.

In an embodiment of the process according to the invention, the diluent in the slurry polymerisation may comprises at least 90% of hydrocarbons having from 3 to 5 carbon atoms.

In an embodiment of the process according to the invention, the second ethylene polymer mixture or multimodal ethylene polymer may have a density of from 939 to 945 kg/m³, preferably 939 to 943 kg/m³.

In the process according to the invention, the first ethylene homopolymer (PE1) preferably has a density of from 955 to 980 kg/m³, ideally 960 to 975 kg/m³. The first ethylene homopolymer (PE1) may also have a density of 965 to 980 kg/m³.

In the process according to the invention, the second ethylene homopolymer (PE2) preferably has a density of from 955 to 980 kg/m³, ideally 960 to 975 kg/m³.

The first ethylene polymer mixture (PEM1) preferably has a density of from 955 to 980 kg/m³, ideally 960 to 975 kg/m³. The first ethylene polymer mixture (PEM1) may also have a density of from 965 to 980 kg/m³.

In an embodiment of the process according to the invention a ratio MFR₂(PEM1)/MFR₂(PE1) is between 1.5:1 to 4:1.

It will be clear that the preferred features described above in relation to the process also apply to the multimodal ethylene polymer itself. The invention also relates to multimodal ethylene polymer and preferred densities, MFRs, ratios, component wt % and so on described above in connection with the process also apply to the polymer itself.

As described above the multimodal ethylene polymer of the present invention is produced in at least three polymerisation steps, and may be trimodal.

### Film

The multimodal ethylene polymer of the invention is ideally made into a film, such as a film for packaging. In addition to the multimodal, preferably trimodal ethylene copolymer, the film composition may also contain antioxidants, process stabilizers, slip agents, pigments, UV-stabilizers and other additives known in the art. Examples of stabilizers are hindered phenols, hindered amines, phosphates, phosphites and phosphonites. Examples of pigments are carbon black, ultramarine blue and titanium dioxide. Examples of other additives are e.g. clay, talc, calcium carbonate, calcium stearate, zinc stearate and antistatic additives like. The additives can be added as single components or as part of a masterbatch as is known in the art.

Suitable antioxidants and stabilizers are, for instance, 2,6-di-tert-butyl-p-cresol, tetrakis-[methylene-3-(3′,5-di-tert-butyl-4′hydroxyphenyl)propionate]methane, octadecyl-3-3(3′5′-di-tert-butyl-4′-hydroxyphenyl)propionate, dilaurylthiodipropionate, distearylthiodipropionate, tris-(nonylphenyl)phosphate, distearyl-pentaerythritol-diphosphite and tetrakis(2,4-di-tert-butylphenyl)-4,4′-biphenylene-diphosphonite.

Some hindered phenols are sold under the trade names of Irganox 1076 and Irganox 1010 or commercially available blends thereof, like Irganox B561. Commercially available blends of antioxidants and process stabilizers are also available, such as Irganox B225 marketed by Ciba-Geigy.

Suitable acid scavengers are, for instance, metal stearates, such as calcium stearate and zinc stearate. They are used in amounts generally known in the art, typically from 300 ppm to 10000 ppm and preferably from 400 to 5000 ppm.

The multimodal ethylene polymer of the invention can be provided in the form of powder or pellets, preferably pellets. Pellets are obtained by conventional extrusion, granulation or grinding techniques and are an ideal form of the polymer of the invention because they can be added directly to converting machinery. Pellets are distinguished from polymer powders where particle sizes are less than 1 mm. The use of pellets ensures that the composition of the invention is capable of being converted in a film, e.g. monolayer film, by the simple in line addition of the pellets to the converting machinery.

The multimodal ethylene polymer of the invention allows the formation of films having good mechanical properties. The composition can be extruded to films according to any method known in the art. The film preparation process steps of the invention are known and may be carried out in a film line in a manner known in the art, such as flat film extrusion or blown film extrusion. Well known film lines are commercially available, for example from Windmöller & Hölscher, Reifenhauser, Hosokawa Alpine etc.

Importantly, the ethylene polymers of the invention have good processing properties. Multimodality, especially trimodality, of the polyethylene film composition of the invention makes it very beneficial for making films. Benefits can be seen in excellent extrudability and especially in the clearly higher throughput in the film making machinery than corresponding film materials having the same level of density and MFR. The high throughput is not achieved at the expense of good mechanical properties.

The films of the invention are preferably monolayer films or the multimodal ethylene polymer of the invention may be used in the formation of a layer within a multilayer film. Any film of the invention may have a thickness of 3 to 1000 μm, preferably 5 to 500 μm, more preferably 10 to 250 μm, still more preferably 10 to 150 μm, such as e.g. 10 to 100 μm, or even 10 to 60 μm. Selected thickness is dependent on the needs of the desired end application. Films of the invention can be stretched uniaxially or biaxially but are preferably non stretched films.

The compositions produced according to the process of the present invention are suitable for making blown films. The films of the invention can be manufactured using simple in line addition of the polymer pellets to an extruder. For film formation using a polymer mixture it is important that the different polymer components be intimately mixed prior to extrusion and blowing of the film as otherwise there is a risk of inhomogeneity, e.g. gels, appearing in the film. Thus, it is especially preferred to thoroughly blend the components, for example using a twin screw extruder, preferably a counter-rotating extruder prior to extrusion and film blowing. Sufficient homogeneity can also be obtained by selecting the screw design for the film extruder such that it is designed for good mixing and homogenizing. The film of the invention is a blown film. Blown films are typically produced by extrusion through an annular die, blowing into a tubular film by forming a bubble which is collapsed between nip rollers after solidification. This film can then be slit, cut or converted (e.g. gusseted) as desired. Conventional film production techniques may be used in this regard. Typically the composition will be extruded at a temperature in the range 160° C. to 240° C., and cooled by blowing gas (generally air) at a temperature of 10 to 50° C. to provide a frost line height of 1 or 2 to 8 times the diameter of the die. The blow up ratio (BUR) should generally be in the range 1.5 to 4, e.g. 2 to 4, preferably 2.5 to 3.

The films of the invention exhibit high dart impact strengths and tear strengths, especially in the machine direction. In the passages which follow, certain parameters are given based on a specific film thickness. This is because variations in thickness of the film cause a change to the size of the parameter in question so to obtain a quantitative value, a specific film thickness is quoted. This does not mean that the invention does not cover other film thicknesses rather it means that when formulated at a given thickness, the film should have the given parameter value.

Thus, for a 40 μm film, impact resistance on film (DDI) (ASTM D1709, method “A”) may be between 200 g and 350 g, further preferred between 210 g and 350 g.

The tensile modulus for a 40 μm film (MD) is preferably between 500 and 700 MPa, preferably 520 to 680, especially 550 to 675 MPa in MD (ISO 527-3).

The Elmendorf tear resistance (MD) measured according to ISO 6383-2 is preferably in the range of 22 to 40 N/mm, such as 25 to 35 N/mm.

It is explicitly preferred, if the multimodal ethylene polymer of the invention (or made by the process of the invention) satisfies the equation:

$${I}_{PM} = ( \frac{Ten sile Modulus MD}{a} ) ( \frac{Dart Drop Impact}{b} ) {( \frac{melt pressure}{c} )}^{d}$$

a=553 MPa, b=236 g, c=271 bar, d=−1.960

and wherein I_{PM} is greater than 1.00, preferably 1.10 or more, e.g. 1.10 to 2.00.

It is explicitly preferred if the multimodal ethylene polymer of the invention (or made by the process of the invention) satisfies the equation:

$${II}_{PM} = ( \frac{Ten sile Modulus MD}{a} ) ( \frac{Dart Drop Impact}{b} ) {( \frac{MFR 21}{e} )}^{f}$$

a=553 MPa, b=236 g, e=38.6 g/10 min, f=0.66;

and II_{PM} is greater than 1.00, preferably 1.10 or more, e.g. 1.10 to 2.00.

It is explicitly preferred if the multimodal ethylene polymer of the invention (or made by the process of the invention) satisfies the equation:

$${III}_{PM} = {( \frac{Ten sile Modulus MD}{a} )}^{2} ( \frac{Dart Drop Impact}{b} ) {( \frac{MFR 21}{e} )}^{f}$$

where a=553 MPa, b=236 g, e=38.6 g/10 min, f=0.45 and III_{PM} is greater than 1.00, III_{PM} is 1.10 or more, e.g. 1.10 to 2.00.

Any dart drop impact values in these equations are determined on a 40 micron film following the protocols below.

The present invention further concerns a process for producing a film, comprising the steps of
(i) polymerising ethylene in a first polymerisation step in the presence of a Ziegler-Natta polymerisation catalyst to produce a first ethylene homopolymer (PE1) having a melt flow rate MFR₂ of from 100 to 300 g/10 min;
(ii) polymerising ethylene in a second polymerisation step in the presence of the first ethylene homopolymer to produce a first ethylene polymer mixture (PEM1) comprising the first ethylene homopolymer and a second ethylene homopolymer, said first ethylene polymer mixture having a melt flow rate MFR₂ of from 200 to 1000 g/10 min, and wherein the MFR₂ of the first ethylene homopolymer (PE1) is lower than first ethylene polymer mixture (PEM1); and
(iii) copolymerising ethylene and at least one alpha-olefin comonomer in a third polymerisation step in the presence of the first ethylene polymer mixture to produce a second ethylene polymer mixture (PEM2) comprising the first ethylene polymer mixture and a third ethylene copolymer (PE3), said second ethylene polymer mixture having a density of from 937 to 950 kg/m³ and a melt flow rate MFR₅ of from 0.1 to 5 g/10 min;
(iv) pelletizing the second polymer mixture; and
(v) providing a film by film blowing.

In one embodiment the multimodal polyethylene polymer of the invention is combined with a post-consumer resin (PCR), i.e. a recycled component to prepare articles such as films. In one embodiment the invention comprises a composition comprising a multimodal ethylene polymer and PCR, such as 10 to 40 wt % PCR. The PCR may comprise LLDPE, or LDPE.

The invention will now be described with reference to the following non limiting examples.

### Methods

The following methods were used to measure the properties that are defined generally above and in examples below. Unless otherwise stated, the film samples used for the measurements and definitions were prepared as described under the heading “Film Sample Preparation”.

### Melt Index (MI) or Melt Flow Rate (MFR)

The melt flow rate (MFR) is determined according to ISO 1133-1 and is indicated in g/10 min. The MFR is an indication of the melt viscosity of the polymer. The MFR is determined at 190° C. for PE. The load under which the melt flow rate is determined is usually indicated as a subscript, for instance MFR₂ is measured under 2.16 kg load, MFR₅ is measured under 5 kg load and MFR₂₁ is measured under 21.6 kg load. MFR values can be determined on samples as explained above or calculated, for example in a way well known in the art, from MFR values determined on samples as explained above, especially for example an MFR value for the second ethylene homo- or copolymer can be calculated based on a measured MFR value for the first ethylene homo- or copolymer, a measured MFR value for the first ethylene polymer mixture and the respective amounts of the first and second ethylene homo- or copolymers, since the MFR of the first ethylene polymer mixture results from the first and second ethylene homo- or copolymers.

An MFR value for the second ethylene homopolymer can be calculated for example based on a logarithmic mixture rule, as for example given by:

$$log {MFR}_{A + B} = {w}_{A} \times log {MFR}_{A} + {w}_{B} \times log {MFR}_{B}$$

where MFR_{A+B} is the MFR of the mixture of A and B, and MFR_{A} and MFR_{B} are the values corresponding to the respective MFR of the two components A and B of the mixture. Finally, WA and WB are the respective fractions of A and B in the mixture, found in the range from 0 to 1 or correspondingly from 0 to 100%, where the sum of the fractions A and B equals 1 or correspondingly 100%. The fractions can be calculated for example as weight fractions.

### Density

Density of the polymer was measured according to ISO 1183-2.

### Co-Monomer Content and Film Thickness

Co-monomer content can be determined according to any suitable method well known in the art to do so, such as for example NMR. Film thickness can be determined according to any suitable method well known in the art to do so, such as for example any suitable measuring device.

### Impact Resistance on Film (DDI)

Impact resistance on film (DDI) was determined by Dart-drop (g/50%). Dart-drop was measured using ASTM D1709, method “A” (Alternative Testing Technique). A dart with a 38 mm diameter hemispherical head was dropped from a height of 0.66 m onto a film clamped over a hole. If the specimen failed, the weight of the dart was reduced and if it did not fail the weight was increased. At least 20 specimens were tested. One weight is used for each set and the weight is increased (or decreased) from set to set by uniform increments. The weight resulting in failure of 50% of the specimens was calculated and reported.

### Relative Tear Resistance (Determined by Elmendorf Tear (N/Mm))

The tear strength or tear resistance is measured using the ISO 6383/2 method. The force required to propagate tearing across a film specimen is measured using a pendulum device. The pendulum swings under gravity through an arc, tearing the specimen from a pre-cut slit. The specimen is fixed on one side by the pendulum and on the other side by a stationary clamp. The tear strength or tear resistance is the force required to tear the specimen. The relative tear resistance (N/mm) can be calculated by dividing the tear resistance by the thickness of the film. The films were produced as described below in the film preparation example. The tear strength or tear resistance is measured in machine direction (MD) and/or transverse direction (TD).

Tensile modulus (E-Mod (MPa) was measured in machine and/or transverse direction according to ISO 527-3 on film samples prepared as described under the Film Sample preparation with film thickness of 40 μm and at a cross head speed of 1 mm/min for the modulus.

### Shear Thinning Index (SHI)

Rheological parameters such as Shear Thinning Index SHI and Viscosity were determined by using an Anton Paar Physica MCR501 Rheometer on compression moulded samples under nitrogen atmosphere at 190° C. using 25 mm diameter plates and plate and plate geometry with a 1.3 mm gap. The oscillatory shear experiments were done within the linear viscosity range of strain at frequencies from 628 to 0.01 rad/s (ISO 6721-1). Five measurement points per decade in frequency were made.

The values of storage modulus (G′), loss modulus (G″), complex modulus (G*) and complex viscosity (η*) were obtained as a function of frequency (ω). η₁₀₀ is used as abbreviation for the complex viscosity at the frequency of 100 rad/s.

Shear thinning index (SHI), which correlates with MWD and is independent of Mw, was calculated according to Heino (“Rheological characterization of polyethylene fractions” Heino, E. L., Lehtinen, A., Tanner J., Seppälä, J., Neste Oy, Porvoo, Finland, Theor. Appl. Rheol., Proc. Int. Congr. Rheol, 11th (1992), 1, 360-362, and “The influence of molecular structure on some rheological properties of polyethylene”, Heino, E. L., Borealis Polymers Oy, Porvoo, Finland, Annual Transactions of the Nordic Rheology Society, 1995).

SHI value is obtained by calculating the complex viscosities at given values of complex modulus and calculating the ratio of the two viscosities. For example, using the values of complex modulus of 5 kPa and 300 kPa, then η*(5 kPa) and η*(300 kPa) are obtained at a constant value of complex modulus of 5 kPa and 300 kPa, respectively. The shear thinning index SHI_{5/300} is then defined as the ratio of the two viscosities η*(5 kPa) and η*(300 kPa), i.e. η(5)/η(300).

### Melt Pressure

The melt pressure is directly determined during the blown film production by means of pressure sensors (for example, Dynisco pressure sensors) located at the end of the extruder, roughly corresponding to the final section of the screw. The pressure range of the sensors is from roughly 0 to 700 bar, with a measurement tolerance of roughly 1.0% of the full scale. The measured pressure is shown directly on a digital display and registered for the corresponding blown film sequence.

### Inventive Example 1 (IE1)

A loop reactor having a volume of 50 dm³ was operated at a temperature of 70° C. and a pressure of 57 bar. Into the reactor were fed ethylene, propane diluent, 1-butene as a comonomer and hydrogen. Also a solid polymerisation catalyst component produced as described in Example 1 of EP 1378528 was introduced into the reactor together with triethylaluminium cocatalyst so that the molar ratio of Al/Ti was about 15. The estimated production split was about 2 wt. %.

A stream of slurry was continuously withdrawn and directed to a loop reactor having a volume of 150 dm³ and which was operated at a temperature of 95° C. and a pressure of 56 bar. Into the reactor were further fed additional ethylene, propane diluent and hydrogen so that the ethylene concentration in the fluid mixture was 4.7 mol % and the molar ratio of hydrogen to ethylene was 264 mol/kmol. The estimated production split was 18 wt. %. The ethylene homopolymer withdrawn from the reactor had MFR₂ of 225 g/10 min.

A stream of slurry from the reactor was withdrawn intermittently and directed into a loop reactor having a volume of 350 dm³ and which was operated at 95° C. temperature and 54 bar pressure. Into the reactor was further added a fresh propane, ethylene, and hydrogen so that the ethylene content in the fluid mixture was 3.4 mol % and the molar ratio of hydrogen to ethylene was 407 mol/kmol. The estimated production split was 33 wt. %. The ethylene homopolymer withdrawn from the reactor had MFR₂ of 420 g/10 min.

The slurry was withdrawn from the loop reactor intermittently and directed to a flash vessel operated at a temperature of 50° C. and a pressure of 3 bar. From there the polymer was directed to a fluidized bed gas phase reactor operated at a pressure of 20 bar and a temperature of 80° C. Additional ethylene, and 1-hexene comonomer, nitrogen as inert gas and hydrogen were added so that the ethylene content in the reaction mixture was 6.3 mol % and the molar ratio of hydrogen to ethylene was 11.1 mol/kmol and the molar ratio of 1-hexene to ethylene was 94.9 mol/kmol. The estimated production split was 48 wt. %.

The polymer powder was mixed under nitrogen atmosphere with 1200 ppm of Irganox B561 and 400 ppm Ca-stearate. Then it was compounded and extruded under nitrogen atmosphere to pellets by using a JSW CIMP90 twin screw extruder. Final properties of IE1 are reported in Table 2.

### IE2 to IE8:

The procedure of IE1 was repeated by changing reactor conditions as described in Table 1.

In Tables 1 and 2 there is a summary polymerisation conditions and material properties for the inventive examples.

TABLE 1

| | IE1 | IE2 | IE3 | IE4 | IE5 | IE6 | IE7 | IE8 |
|---|---|---|---|---|---|---|---|---|
| Prepoly reactor | | | | | | | | |
| Temperature (° C.) | 70 | 70 | 70 | 70 | 70 | 70 | 70 | 70 |
| Pressure (kPa) | 5721 | 5749 | 5745 | 5775 | 5762 | 5777 | 5783 | 5772 |
| Split (wt %) | 2 | 2 | 2 | 2 | 2 | 2 | 2 | 2 |
| First loop reactor | | | | | | | | |
| Temperature (° C.) | 95 | 95 | 95 | 95 | 95 | 95 | 95 | 95 |
| Pressure (kPa) | 5558 | 5559 | 5560 | 5557 | 5557 | 5503 | 5512 | 5506 |
| C2 (mol %) | 4.7 | 4.2 | 5.1 | 3.8 | 4.4 | 4.9 | 4.7 | 4.8 |
| H2/C2 (mol/kmol) | 264 | 320 | 264 | 350 | 294 | 308 | 306 | 300 |
| MFR2 (g/10 min) | 225 | 220 | 170 | 234 | 173 | 205 | 195 | 185 |
| Split (wt %) | 18 | 18 | 15 | 17 | 17 | 18 | 18 | 18 |
| Second loop | | | | | | | | |
| reactor | | | | | | | | |
| Temperature (° C.) | 95 | 95 | 95 | 95 | 95 | 95 | 95 | 95 |
| Pressure (kPa) | 5396 | 5396 | 5396 | 5396 | 5398 | 5392 | 5382 | 5384 |
| C2 (mol %) | 3.4 | 3.1 | 3.1 | 2.6 | 2.7 | 5.6 | 5.5 | 5.5 |
| H2/C2 (mol/kmol) | 407 | 470 | 439 | 496 | 467 | 606 | 563 | 555 |
| Split (wt %) | 32 | 32 | 29 | 29 | 27 | 26 | 26 | 26 |
| PEM1 | | | | | | | | |
| MFR2 (g/10 min) | 420 | 500 | 448 | 410 | 469 | 420 | 390 | 360 |
| Gas phase reactor | | | | | | | | |
| Temperature (° C.) | 80 | 80 | 80 | 80 | 80 | 82 | 82 | 82 |
| Pressure (kPa) | 2000 | 2000 | 2000 | 2000 | 2000 | 1985 | 1988 | 2003 |
| C2 (mol %) | 6.3 | 6.7 | 8.7 | 7.3 | 7.8 | 13.2 | 13.1 | 13.3 |
| H2/C2 (mol/kmol) | 11.1 | 18.8 | 26.6 | 28.6 | 37.9 | 22.0 | 22.0 | 21.9 |
| C4/C2 (mol/kmol) | 0 | 0 | 0 | 0 | 0 | 98.1 | 94.4 | 92.1 |
| C6/C2 (mol/kmol) | 94.9 | 111.2 | 90.0 | 91.3 | 90.8 | 128.0 | 123.5 | 121.8 |
| Split (wt %) | 48 | 48 | 54 | 52 | 54 | 54 | 54 | 54 |

The polymer powder was mixed under nitrogen atmosphere with 1200 ppm of Irganox B561 and 400 ppm Ca-stearate. Then it was compounded and extruded under nitrogen atmosphere to pellets by using a JSW CIMP90 twin screw extruder. Properties are reported in Table 2.

TABLE 2

| | | Loop1 split | Measured | | | | | | | | |
|---|---|---|---|---|---|---|---|---|---|---|---|
| | Measured | including | Loop1 + 2 | | Calculated | | Pellet | Pellet | Pellet | Pellet | Total |
| | Loop1 MFR2 | prepoly | MFR2 | Loop2 split | Loop2 MFR2 | GPR split | density | MFR2 | MFR5 | MFR21 | split |
| | (g/10 min) | (%) | (g/10 min) | (%) | (g/10 min) | (%) | (kg/m³) | (g/10 min) | (g/10 min) | (g/10 min) | (%) |
| IE1 | 225 | 20 | 420 | 32 | 620 | 48 | 941.5 | 0.20 | 0.84 | 25.0 | 100 |
| IE2 | 220 | 20 | 500 | 32 | 835 | 48 | 941.0 | 0.44 | 1.9 | 51.7 | 100 |
| IE3 | 170 | 17 | 448 | 29 | 791 | 54 | 941.8 | 0.29 | 1.1 | 26.2 | 100 |
| IE4 | 234 | 19 | 410 | 29 | 592 | 52 | 943.2 | 0.37 | 1.5 | 38.7 | 100 |
| IE5 | 173 | 19 | 469 | 27 | 946 | 54 | 941.9 | 0.50 | 2.0 | 41.6 | 100 |
| IE6 | 205 | 20 | 420 | 26 | 729 | 54 | 940.7 | 0.38 | 1.58 | 35.2 | 100 |
| IE7 | 195 | 20 | 390 | 26 | 665 | 54 | 940.7 | 0.35 | 1.45 | 32.3 | 100 |
| IE8 | 185 | 20 | 360 | 26 | 601 | 54 | 941.0 | 0.36 | 1.44 | 32.4 | 100 |

As comparative material 1 was used commercial linear low density polyethylene film grade Borstar® FX1001 having the density of 932 kg/m³ and MFR₅ of 0.9 g/10 min.

As comparative material 2 was used commercial linear low density polyethylene film grade Borstar® FX1002 having the density of 937 kg/m³ and MFR₅ of 1.9 g/10 min.

As comparative material 3 was used was used commercial linear low density polyethylene film grade 40ST05 SuperTough having the density of 940 kg/m³ and MFR₅ of 1.9 g/10 min.

As comparative material 4 was used commercial linear low density polyethylene film grade 4002MC Enable having the density of 940 kg/m³ and MFR₅ of 1.3 g/10 min.

Properties of the comparative examples are summarised in table 3.

TABLE 3

| Commercial | Pellet density, | Pellet MFR5, | Pellet MFR21, |
|---|---|---|---|
| grade | kg/m³ | g/10 min | g/10 min |
| CE1 | 932 | 0.9 | 18.5 |
| CE2 | 937 | 1.9 | 38.6 |
| CE3 | 940 | 1.9 | 21.9 |
| CE4 | 940 | 1.3 | 18.4 |

### Film Preparation Method

Blown films were made in a W&H (Windmöller & Hölscher) monolayer blown film line. The extruder has 4 heating zones and the temperature settings for an extrusion temperature of e.g. 220° C. are for example 190° C., 200° C., 210° C. and 220° C. for heating zones 1 to 4, respectively. Further the following parameters were used: Blow Up Ratio (BUR) of 3.0; frost line height of 700 mm, which is about 3 times the die diameter (200 mm); and die gap between 1 mm and 2 mm.

Blow Up Ratio (BUR) is defined to be the Diameter of the bubble divided by the Diameter of the die (represents TD orientation).

BUR indicates the increase in the bubble diameter over the die diameter. A blow-up ratio greater than 1 indicates that the bubble has been blown to a diameter greater than that of the die orifice. Maximum output rate (kg/h) was tested for materials at 40 micron film thickness.

TABLE 4
Processing parameters, producing 40 μm blown film monolayer, melt
temperature 230° C., BUR 1:3, frost line height 700 mm

| | Pellet MFR5 (g/10 min) | Melt pressure at W&H line (bar) |
|---|---|---|
| IE1 | 0.84 | 304 |
| IE2 | 1.9 | 241 |
| IE4 | 1.5 | 277 |
| IE5 | 2.0 | 253 |
| CE1 | 0.9 | 347 |
| CE2 | 1.9 | 271 |
| CE3 | 1.9 | 286 |
| CE4 | 1.3 | 303 |

TABLE 5
Film mechanical properties 40 μm blown film monolayer

| Exam- | Dart Drop Impact | Tensile Modulus MD | Tear Elmendorf MD |
|---|---|---|---|
| ple | ISO 7765-1 g | ISO 527-3 MPa | ISO 6383-2 N/mm |
| IE1 | 300 | 580 ± 13 | 26 ± 2.2 |
| IE2 | 238 | 591 ± 16 | 28 ± 1.5 |
| IE4 | 234 | 609 ± 30 | 26 ± 0.93 |
| IE5 | 202 | 609 ± 18 | 29 ± 0.07 |
| CE1 | 448 | 473 ± 28 | 52 ± 2.3 |
| CE2 | 236 | 553 ± 12 | 38 ± 2.1 |
| CE3 | 124 | 617 ± 19 | 15 ± 0.69 |
| CE4 | 136 | 600 ± 14 | 12 ± 0.27 |

In order to quantify the benefit on Processability and Mechanical performance of the inventive solution a “First Index of Processability and Mechanical performance”, I_{PM}, is defined as:

$${I}_{PM} = ( \frac{Ten sile Modulus MD}{a} ) ( \frac{Dart Drop Impact}{b} ) {( \frac{melt pressure}{c} )}^{d}$$

where
a=553 MPa, b=236 g, c=271 bar, d=−1.960 defined to make I_{PM} of CE2 equal to 1

Therefore if/PM>1.00, or better/PM>1.10, then we have an improvement in overall Processability and Mechanical performance, i.e. overall higher processability (lower melt pressure) and mechanical performance than CE1 or CE2.

In Table 6, the First Index of Processability and Mechanical performance of the Inventive and Comparative Examples is summarized. In particular IE2 shows the best performance according to the First Index I_{PM}.

TABLE 6
First Index of Processability and Mechanical performance

| | I_{PM} |
|---|---|
| IE1 | 1.06 |
| IE2 | 1.36 |
| IE4 | 1.05 |
| IE5 | 1.08 |
| IE6 | 1.29 |
| IE7 | 1.15 |
| IE8 | 1.16 |
| CE1 | 1.00 |
| CE2 | 1.00 |
| CE3 | 0.53 |
| CE4 | 0.50 |

“Second Index of Processability and Mechanical performance”, II_{PM}, can be defined as:

$${II}_{PM} = ( \frac{Ten sile Modulus MD}{a} ) ( \frac{Dart Drop Impact}{b} ) {( \frac{MFR 21}{e} )}^{f} \qquad ( eq . 2 )$$

where
a=553 MPa, b=236 g, e=38.6 g/10 min, f=0.66 defined to make II_{PM} of CE2 equal to 1

Therefore if II_{PM}>1.00, or better II_{PM}>1.10, then we have an improvement in overall Processability and Mechanical performance, i.e. overall higher processability (lower melt pressure linked to higher MFR₂₁) and mechanical performance than CE1 or CE2.

TABLE 7
The Second Index of Processability and
Mechanical performance (using MFR₂₁)

| | II_{PM} |
|---|---|
| IE1 | 1.00 |
| IE2 | 1.31 |
| IE4 | 1.09 |
| IE5 | 0.99 |
| IE6 | 1.03 |
| IE7 | 1.07 |
| IE8 | 1.15 |
| CE1 | 1.00 |
| CE2 | 1.00 |
| CE3 | 0.40 |
| CE4 | 0.38 |
| IE1* | 0.72 |
| IE2* | 0.74 |
| IE3* | 0.78 |

IE1* to IE3* are examples IE1 to IE3 of WO 2020/136164

In Table 7, the Second Index of Processability and Mechanical performance (using MFR₂₁) of the Inventive and Comparative Examples is summarized. In particular IE2 shows the best performance according to the Second Index.

Finally, the IEs were characterized and some main features are reported in Table 8.

TABLE 8

| | | | | | | | | | Shear |
|---|---|---|---|---|---|---|---|---|---|
| | | | | | | C = C/kCHn | | η(0.05 | Thinning |
| | Mₙ | M_{w} | M_{z} | Tₘ | T_{cr} | total | C6 | rad/s) | Index |
| | (g/mol) | (g/mol) | (g/mol) | (° C.) | (° C.) | unsaturation | (wt %) | (Pa · s) | (5/300) |
| IE1 | 7800 | 193500 | 1140000 | 129.0 | 116.1 | 0.13 | 4.1 | 61800 | 106 |
| IE2 | 7125 | 160500 | 967500 | 128.5 | 116.2 | 0.14 | 4.7 | 33200 | 140 |
| IE4 | 7505 | 167000 | 919500 | 128.7 | 115.8 | 0.13 | 3.7 | 35100 | 64 |
| IE5 | 7205 | 148500 | 829500 | 128.9 | 115.2 | 0.13 | 3.9 | 27600 | 49 |

TABLE 9
Processing parameters at W&H line, producing 40 μm blown
film monolayer, melt temperature 220° C., BUR
1:3, frost line height 700 mm

| | Pellet MFR5, | Melt pressure at |
|---|---|---|
| | g/10 min | W&H line, bar |
| IE6 | 1.58 | 249 |
| IE7 | 1.45 | 277 |
| IE8 | 1.44 | 286 |

TABLE 10
Film mechanical properties

| | Dart Drop | Tensile Modulus | Tear |
|---|---|---|---|
| | Impact | MD | Elmendorf MD |
| | ISO 7765-1 | ISO 527-3 | ISO 6383-2 |
| | g | MPa | N/mm |
| IE6 | 225 | 634 ± 15 | 29 ± 1.7 |
| IE7 | 247 | 636 ± 12 | 27 ± 1.5 |
| IE8 | 266 | 631 ± 15 | 28 ± 2.3 |

“Third Index of Processability and Mechanical performance”, III_{PM}, can be defined as:

$${III}_{PM} = {( \frac{Ten sile Modulus MD}{a} )}^{2} ( \frac{Dart Drop Impact}{b} ) {( \frac{MFR 21}{e} )}^{f} where \qquad ( eq . 3 )$$

a=553 MPa, b=236 g, e=38.6 g/10 min, defined to make III_{PM} of CE2 equal to 1
f=0.45 defined to make III_{PM} of CE1 or CE2 equal to 1

Therefore if III_{PM}>1.00, or better III_{PM}>1.10, then we have an improvement in overall Processability and Mechanical performance, i.e. overall higher processability (lower melt pressure linked to higher MFR₂₁) and mechanical performance than CE2.

TABLE 11
The Third Index of Processability and
Mechanical performance (using MFR₂₁)

| | III_{PM} |
|---|---|
| IE1 | 1.15 |
| IE2 | 1.31 |
| IE4 | 1.20 |
| IE5 | 1.07 |
| IE6 | 1.20 |
| IE7 | 1.28 |
| IE8 | 1.36 |
| CE1 | 1.00 |
| CE2 | 1.00 |
| CE3 | 0.51 |
| CE4 | 0.49 |
| IE1* | 0.68 |
| IE2* | 0.72 |
| IE3* | 0.73 |

IE1* to IE3* are examples IE1 to IE3 of WO 2020/136164

In Table 11 the Third Index of Processability and Mechanical performance (using MFR₂₁) of the Inventive and Comparative Examples is summarized. The power 2 in the contribution of the Tensile Modulus, i.e. stiffness, to the Third Index in Equation 3 makes it more sensitive to the improvement in stiffness and thus it is reflected in the results.

1. A process for producing a multimodal ethylene polymer comprising the steps of:
(i) polymerising ethylene in a first polymerisation step in the presence of a Ziegler-Natta polymerisation catalyst to produce a first ethylene homopolymer (PE1) having a melt flow rate MFR₂ of from 100 to 300 g/10 min (ISO 1133-1 at 190° C. under 2.16 kg load);
(ii) polymerising ethylene in a second polymerisation step in the presence of the first ethylene homopolymer to produce a first ethylene polymer mixture (PEM1) comprising the first ethylene homopolymer and a second ethylene homopolymer, said first ethylene polymer mixture having a melt flow rate MFR₂ of from 200 to 1000 g/10 min (ISO 1133-1 at 190° C. under 2.16 kg load), and wherein the MFR₂ of the first ethylene homopolymer (PE1) is lower than the MFR₂ of the first ethylene polymer mixture (PEM1); and
(iii) copolymerising ethylene and at least one alpha-olefin comonomer in a third polymerisation step in the presence of the first ethylene polymer mixture to produce a second ethylene polymer mixture (PEM2) comprising the first ethylene polymer mixture and a third ethylene copolymer (PE3), said second ethylene polymer mixture having a density of from 937 to 950 kg/m³ (ISO 1183-2) and a melt flow rate MFR₅ of from 0.1 to 5.0 g/10 min (ISO 1133-1 at 190° C. under 5 kg load).

2. The process according to claim 1, wherein the third ethylene copolymer forms 45 to 65 wt % of the second ethylene polymer mixture (PEM2).

3. The process according to claim 1, wherein the α-olefin comonomer is selected from the group consisting of α-olefins having from 4 to 10 carbon atoms or mixtures thereof.

4. The process according to claim 1, wherein the third polymerisation step is conducted in gas phase; and wherein at least one of the first and the second polymerisation step(s) is/are conducted as a slurry polymerisation in a loop reactor.

5. The process according to claim 1, wherein the second ethylene polymer mixture (PEM2) comprises from 10 to 30% by weight of the first ethylene homopolymer, and from 15 to 35% by weight of the second ethylene homopolymer.

6. The process according to claim 1, wherein the second ethylene polymer mixture (PEM2) has a density of from 937 to 945 kg/m³.

7. The process according to claim 1, wherein the second ethylene polymer mixture (PEM2) has a melt flow rate MFR₅ of from 0.5 to 5.0 g/10 min.

8. The process according to claim 1, wherein:
the first ethylene homopolymer (PE1) has a density of from 965 to 980 kg/m³ and/or a melt flow rate MFR₂ of from 100 to 300 g/10 min, and/or
the first ethylene polymer mixture (PEM1) has a density of from 965 to 980 kg/m³ and a melt flow rate MFR₂ of from 300 to 600 g/10 min.

9. The process according to claim 1, wherein a ratio MFR₂(PEM1)/MFR₂(PE1) is between 1.5:1 to 4:1.

10. A multimodal ethylene polymer having density of from 937 to 950 kg/m³ (ISO 1183-2) and a melt flow rate MFR₅ of from 0.1 to 5.0 g/10 min (ISO 1133-1 at 190° C. under 5 kg load) comprising:
i) 10 to 30 wt % of a first ethylene homopolymer (PE1);
ii) 15 to 35 wt % a second ethylene homopolymer (PE2) having an MFR₂ which is at least 50 g/10 min higher than a MFR₂ of component i) (ISO 1133-1 at 190° C. under 2.16 kg load); and
iii) 40 to 65 wt % of a third ethylene copolymer with at least one alpha-olefin comonomer (PE3).

11. The multimodal ethylene polymer as claimed in claim 10, wherein the third ethylene copolymer is an ethylene 1-hexene copolymer or a terpolymer of ethylene and at least two alpha-olefin comonomers.

12. The multimodal ethylene polymer as claimed in claim 10, wherein:
$${I}_{PM} = ( \frac{Ten sile Modulus MD}{a} ) ( \frac{Dart Drop Impact}{b} ) {( \frac{melt pressure}{c} )}^{d}$$
where a=553 MPa, b=236 g, c=271 bar, and d=−1.960,
wherein I_{PM} is greater than 1.00; and
wherein:
Dart drop Impact was determined on a 40 μm film by Dart-drop (g/50%) using ASTM D1709, method “A” (Alternative Testing Technique), and
Tensile modulus MD was measured in machine direction according to ISO 527-3 on 40 μm film samples.

13. The multimodal ethylene polymer as claimed in claim 10, wherein:
$${II}_{PM} = ( \frac{Ten sile Modulus MD}{a} ) ( \frac{Dart Drop Impact}{b} ) {( \frac{MFR 21}{e} )}^{f}$$
where a=553 MPa, b=236 g, c=38.6 g/10 min, f=0.66, and II_{PM} is greater than 1.00;
or
$${III}_{PM} = {( \frac{Ten sile Modulus MD}{a} )}^{2} ( \frac{Dart Drop Impact}{b} ) {( \frac{MFR 21}{e} )}^{f}$$
where a=553 MPa, b=236 g, e=38.6 g/10 min, f=0.45, and III_{PM} is greater than 1.00;
wherein:
Dart drop Impact was determined on a 40 μm film by Dart-drop (g/50%) using ASTM D1709, method “A” (Alternative Testing Technique);
Tensile modulus MD was measured in machine direction according to ISO 527-3 on 40 μm film samples; and
MFR21 was determined according to ISO 1133-1 at 190° C. under 21.6 kg load.

14. The process for producing a film, comprising the steps as defined in claim 1 followed by
iv) pelletizing the second polymer mixture; and
v) providing a film by film blowing.

15. A film comprising the multimodal film composition of claim 10.

16. The process according to claim 1, wherein the α-olefin comonomer is selected from the group consisting of α-olefins having from 4 to 8 carbon atoms or mixtures thereof.

17. The process according to claim 1, wherein the α-olefin comonomer is selected from the group consisting of 1-butene, 1-hexene and 1-octene or mixtures thereof.

18. The process according to claim 1, wherein the α-olefin comonomer in the third polymerisation step is: 1-butene and 1-hexene; or 1-hexene alone.

19. The process according to claim 1, wherein the third polymerisation step is conducted in a gas phase fluidized bed reactor.

20. The process according to claim 1, wherein the first and second polymerisation steps are conducted in a slurry polymerisation in two loop reactors.
